(19) United States
(12) Patent Application Publication
(10) Pub. No.: US 2023/0316482 A1
(43) Pub. Date: Oct. 5, 2023

(54) IMAGE MONITORING DEVICE

(71) Applicant: Panasonic Intellectual Property Management Co., Ltd., Osaka (JP)

(72) Inventors: Tomoyuki TSURUBE, TOKYO TO (JP); Naokazu IWATA, TOKYO TO (JP)

(73) Assignee: Panasonic Intellectual Property Management Co., Ltd., Osaka (JP)

(21) Appl. No.: 18/101,444

(22) Filed: Jan. 25, 2023

(30) Foreign Application Priority Data
Mar. 29, 2022 (JP) 2022-054056

(51) Int. Cl. H04N 17/00; G06T 7/00; B60R 1/20

(52) U.S. Cl. CPC G06T 7/0002; B60R 1/20; H04N 17/002; G06T 2207/30168; G06T 2207/30252; H04N 23/90

(57) ABSTRACT

An image monitoring device according to the present disclosure includes a memory and one or more hardware processors coupled to the memory and configured to function as an acquisition unit and a notification unit. The acquisition unit acquires an image of an outside of a vehicle that is captured by an imaging unit. In a case where a given condition is satisfied in the image, the notification unit notifies that dirt adheres to a lens of the imaging unit. Then, in a case where a flat region being a region, for which a difference in luminance value among pixels included in the image is small and which has flat luminance values, gets narrower in a width direction of the region as getting farther from the vehicle in the image, the notification unit does not notify that the dirt adheres to a lens of the imaging unit.

### CROSS-REFERENCE TO RELATED APPLICATIONS

This application is based upon and claims the benefit of priority from Japanese Pat. Application No. 2022-054056, filed on Mar. 29, 2022, the entire contents of which are incorporated herein by reference.

### FIELD

The present disclosure relates to an image monitoring device.

### BACKGROUND

Conventionally, a vehicle executes various types of processing in accordance with a surrounding situation of the vehicle that is recognized based on an image captured by an in-vehicle camera. In a case where a lens of the in-vehicle camera is dirty, the vehicle cannot recognize the surrounding situation of the vehicle. In view of the foregoing, a technique of determining whether or not dirt adheres to a lens of an in-vehicle camera, based on an image captured by the in-vehicle camera has been known. Such a technique determines whether or not dirt adheres to a lens, based on the number of blocks with flat luminance values that are included in an image captured by the in-vehicle camera (i.e., based on a width of a region with flat luminance values). In addition, by acquiring a histogram for a small region in an image, and detecting that there is no temporal change in the histogram, it is determined whether or not dirt adheres to a lens.

Nevertheless, even if dirt does not adhere to a lens, a region with flat luminance values is sometimes formed in an image captured by an in-vehicle camera. In addition, even if dirt does not adhere to a lens, a case where there is no temporal change in the histogram of the small region in the image sometimes takes place. In this case, an image monitoring device sometimes falsely detects that dirt adheres to a lens.

### BRIEF DESCRIPTION OF THE DRAWINGS

FIG. 1 is a diagram illustrating an example of a vehicle including an in-vehicle device according to a first embodiment;

FIG. 2 is a diagram illustrating an example of a configuration in the vicinity of a driving seat of the vehicle according to the first embodiment;

FIG. 3 is a diagram illustrating an example of a hardware configuration of the in-vehicle camera according to the first embodiment;

FIG. 4 is a block diagram illustrating an example of a functional configuration of an image processing unit according to the first embodiment;

FIG. 5 is a diagram illustrating an example of a first captured image;

FIG. 6 is a diagram illustrating an example of a second captured image;

FIG. 7 is a graph illustrating an example of a shape of a shadow of a vehicle; and

FIG. 8 is a flowchart illustrating an example of shadow determination processing to be executed by the image processing unit according to the first embodiment.

### DETAILED DESCRIPTION

An image monitoring device according to the present disclosure includes a memory and one or more hardware processors coupled to the memory and configured to function as an acquisition unit and a notification unit. The acquisition unit is configured to acquire an image of an outside of a vehicle that is captured by an imaging unit. The notification unit is configured to, in a case where a given condition is satisfied in the image, notify that dirt adheres to a lens of the imaging unit. In a case where a flat region being a region, for which a difference in luminance value among pixels included in the image is small and which has flat luminance values, gets narrower in a width direction of the region as getting farther from the vehicle in the image, the notification unit does not notify that the dirt adheres to the lens of the imaging unit.

Herein, the present disclosure provides an image monitoring device that can prevent false detection of a state in which dirt adheres to a lens of an in-vehicle camera.

According to the image monitoring device according to the present disclosure, it is possible to prevent false detection of a state in which dirt adheres to a lens of an in-vehicle camera.

Hereinafter, an embodiment of an image monitoring device according to the present disclosure will be described with reference to the drawings.

### First Embodiment

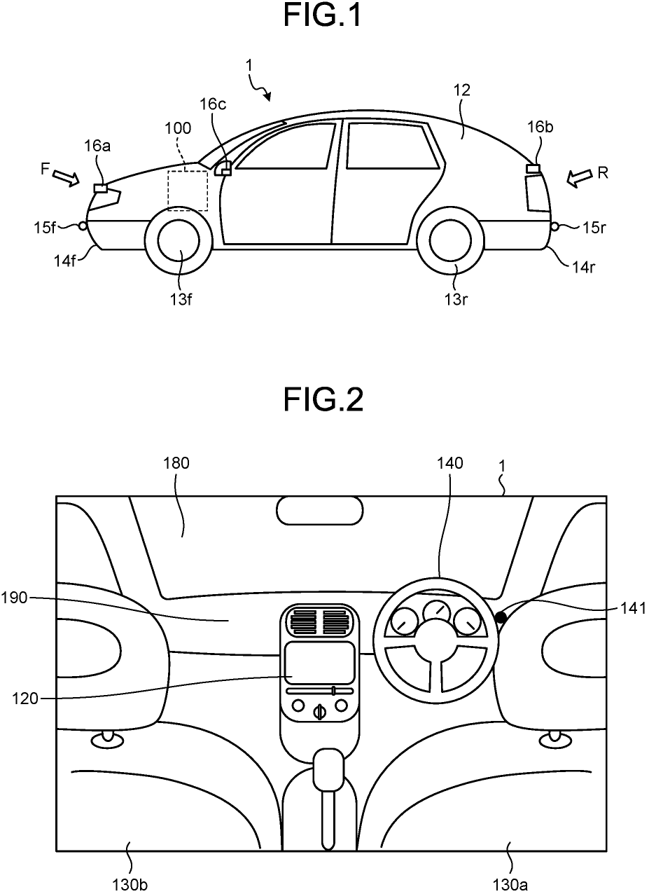

FIG. 1 is a diagram illustrating an example of a vehicle 1 including an in-vehicle device 100 according to a first embodiment. As illustrated in FIG. 1, the vehicle 1 includes a vehicle body 12, and two pairs of wheels 13 arranged on the vehicle body 12 along a given direction. The two pairs of wheels 13 include a pair of front tires 13f and a pair of rear tires 13r.

Note that the vehicle 1 illustrated in FIG. 1 includes four wheels 13, but the number of wheels 13 is not limited to this. For example, the vehicle 1 may be a two-wheeled vehicle.

The vehicle body 12 is coupled to the wheels 13, and can be moved by the wheels 13. In this case, the given direction in which the two pairs of wheels 13 are arranged corresponds to a traveling direction of the vehicle 1. The vehicle 1 can move forward or backward by the switching of gears (not illustrated) or the like. In addition, the vehicle 1 can also turn right or left by steerage.

In addition, the vehicle body 12 includes a front end portion F being an end portion on the front tire 13f side, and a rear end portion R being an end portion on the rear tire 13r side. The vehicle body 12 has an approximately-rectangular shape in a top view, and each of four corner portions of the approximately-rectangular shape is sometimes called an end portion. In addition, the vehicle 1 includes a display device, a speaker, and an operation unit, which are not illustrated in FIG. 1.

A pair of bumpers 14 are provided near the lower ends of the vehicle body 12 at the front and rear end portions F and R of the vehicle body 12. Out of the pair of bumpers 14, a front bumper 14f covers the entire front surface and a part of a side surface near a lower end portion of the vehicle body 12. Out of the pair of bumpers 14, a rear bumper 14r covers the entire rear surface and a part of a side surface near a lower end portion of the vehicle body 12.

Wave transmission/receiving units 15f and 15r that perform transmission/reception of sound waves such as ultrasound waves are arranged at given end portions of the vehicle body 12. For example, one or more wave transmission/receiving units 15f are arranged on the front bumpers 14f, and one or more wave transmission/receiving units 15r are arranged on the rear bumper 14r. Hereinafter, in a case where discrimination between the transmission/receiving units 15f and 15r is not specifically required, the transmission/receiving units 15f and 15r will be simply referred to as wave transmission/receiving units 15 In addition, the number and positions of the wave transmission/receiving units 15 are not limited to those in the example illustrated in FIG. 1. For example, the vehicle 1 may include the wave transmission/receiving units 15 on the left and right lateral sides.

In the present embodiment, sonars that use ultrasound waves are employed as an example of the wave transmission/receiving units 15, but the wave transmission/receiving units 15 may be radars that transmit and receive electromagnetic waves. Alternatively, the vehicle 1 may include both of a sonar and a radar. In addition, the wave transmission/receiving units 15 may be simply referred to as sensors.

The wave transmission/receiving units 15 detect a surrounding obstacle of the vehicle 1 based on a transmission/receiving result of sound waves or electromagnetic waves. In addition, the wave transmission/receiving units 15 measure a distance between a surrounding obstacle of the vehicle 1, and the vehicle 1 based on a transmission/receiving result of sound waves or electromagnetic waves.

In addition, the vehicle 1 includes a first in-vehicle camera 16a that captures an image of a front side of the vehicle 1, a second in-vehicle camera 16b that captures an image of a rear side of the vehicle 1, a third in-vehicle camera 16c that captures an image of a left lateral side of the vehicle 1, and a fourth in-vehicle camera that captures an image of a right lateral side of the vehicle 1. The illustration of the fourth in-vehicle camera is omitted in the drawings.

Hereinafter, in a case where discrimination between the first in-vehicle camera 16a, the second in-vehicle camera 16b, the third in-vehicle camera 16c, and the fourth in-vehicle camera is not specifically required, the in-vehicle cameras will be simply referred to as in-vehicle cameras 16. The positions and the number of in-vehicle cameras 16 are not limited to those in the example illustrated in FIG. 1. For example, the vehicle 1 may include only two in-vehicle cameras corresponding to the first in-vehicle camera 16a and the second in-vehicle camera 16b. Alternatively, the vehicle 1 may further include another in-vehicle camera aside from the above-described in-vehicle cameras.

The in-vehicle camera 16 is a camera that can capture a video of the periphery of the vehicle 1, and captures a color image, for example. Note that data of images captured by the in-vehicle camera 16 may include moving images, or may include still images. In addition, the in-vehicle camera 16 may be a camera built in the vehicle 1, or may be a camera such as a drive recorder that is retrofitted to the vehicle 1.

In addition, the in-vehicle device 100 is mounted on the vehicle 1. The in-vehicle device 100 is an information processing device mountable on the vehicle 1, and is an electronic control unit (ECU) or an on board unit (OBU) that is provided inside the vehicle 1, for example. Alternatively, the in-vehicle device 100 may be an external device installed near a dashboard of the vehicle 1. Note that the in-vehicle device 100 may also serve as a car navigation device or the like.

Next, a configuration in the vicinity of a driving seat of the vehicle 1 according to the present embodiment will be described. FIG. 2 is a diagram illustrating an example of a configuration in the vicinity of a driving seat 130a of the vehicle 1 according to the first embodiment.

As illustrated in FIG. 2, the vehicle 1 includes the driving seat 130a and a front passenger seat 130b. In addition, a front glass 180, a dashboard 190, a steering wheel 140, a display device 120, and an operation button 141 are provided on the front side of the driving seat 130a.

The display device 120 is a display provided on the dashboard 190 of the vehicle 1. As an example, the display device 120 is positioned at the center of the dashboard 190 as illustrated in FIG. 2. The display device 120 is a liquid crystal display or an organic electro luminescence (EL) display, for example. In addition, the display device 120 may also serve as a touch panel. The display device 120 is an example of a display unit in the present embodiment.

In addition, the steering wheel 140 is provided in front of the driving seat 130a, and is operable by a driver (operator). A rotational angle of the steering wheel 140 (i.e., steering angle) electrically or mechanically interlocks with a change in the orientation of the front tire 13f being a steerage wheel. Note that the steerage wheel may be the rear tire 13r, or both of the front tire 13f and the rear tire 13r may function as steerage wheels.

The operation button 141 is a button that can receive an operation performed by a user. Note that, in the present embodiment, the user is an operator of the vehicle 1, for example. Note that the position of the operation button 141 is not limited to that in the example illustrated in FIG. 2, and may be provided on the steering wheel 140, for example. The operation button 141 is an example of an operation unit in the present embodiment. In addition, in a case where the display device 120 also serves as a touch panel, the display device 120 may serve as an example of an operation unit. In addition, an operation terminal (not illustrated) that can transmit a signal to the vehicle 1 from the outside of the vehicle 1, such as a tablet terminal, a smartphone, a remote controller, or an electronic key, may serve as an example of an operation unit.

Next, a hardware configuration of the in-vehicle camera 16 according to the present embodiment will be described.

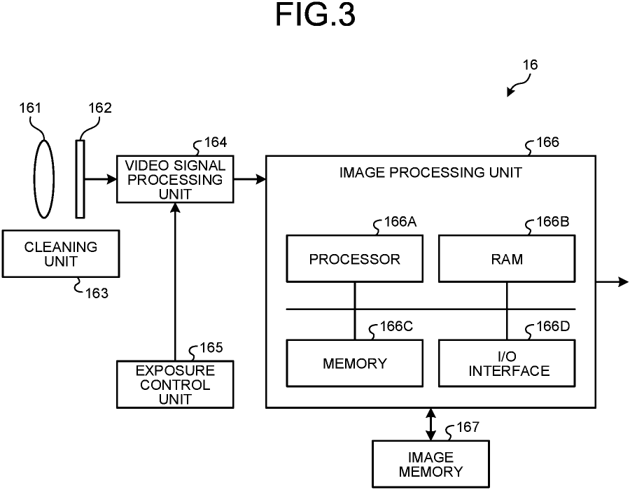

FIG. 3 is a diagram illustrating an example of a hardware configuration of the in-vehicle camera 16 according to the first embodiment. As illustrated in FIG. 3, the in-vehicle camera 16 includes a lens 161, an image sensor 162, a cleaning unit 163, a video signal processing unit 164, an exposure control unit 165, an image processing unit 166, and an image memory 167.

The lens 161 is formed of transparent material. Then, the lens 161 diffuses or converges incident light.

The image sensor 162 is an image sensor such as a complementary metal-oxide semiconductor (CMOS) sensor or a charge coupled device (CCD) sensor. The image sensor 162 receives light having passed through the lens 161, and converts the light into a video signal.

The cleaning unit 163 is a device that cleans off dirt adhering to the lens 161, by jetting water or the like to the lens 161.

The video signal processing unit 164 generates an image based on a video signal output from the image sensor 162. The exposure control unit 165 controls the brightness of the image generated by the video signal processing unit 164. In other words, the video signal processing unit 164 generates an image with brightness controlled by the exposure control unit 165. For example, in a case where an image is dark, the exposure control unit 165 increases the brightness of the image. On the other hand, in a case where an image is bright, the exposure control unit 165 decreases the brightness of the image.

The image processing unit 166 executes various types of image processing on an image generated by the video signal processing unit 164. The image memory 167 is a main storage device of the image processing unit 166. The image memory 167 is used as a working memory of image processing to be executed by the image processing unit 166.

The image processing unit 166 includes a computer and the like, and controls image processing by hardware and software cooperating with each other. For example, the image processing unit 166 includes a processor 166A, a random access memory (RAM) 166B, a memory 166C, and an input/output (I/O) interface 166D.

The processor 166A is a central processing unit (CPU) that can execute a computer program, for example. Note that the processor 166A is not limited to a CPU. For example, the processor 166A may be a digital signal processor (DSP), or may be another processor.

The RAM 166B is a volatile memory to be used as a cache or a buffer. The memory 166C is a non-volatile memory that stores various types of information including computer programs, for example. The processor 166A implements various functions by reading out specific computer programs from the memory 166C, and loading the computer programs onto the RAM 166B.

The I/O interface 166D controls input/output of the image processing unit 166. For example, the I/O interface 166D executes communication with the video signal processing unit 164, the image memory 167, and the in-vehicle device 100.

Note that the cleaning unit 163 may be an independent device without being formed integrally with the in-vehicle camera 16. In addition, installation positions of the image processing unit 166 and the image memory 167 are not limited to positions inside the in-vehicle camera 16. The image processing unit 166 and the image memory 167 may be provided in the in-vehicle device 100, may be independent devices, or may be embedded in another device.

Next, functions included in the image processing unit 166 according to the first embodiment will be described.

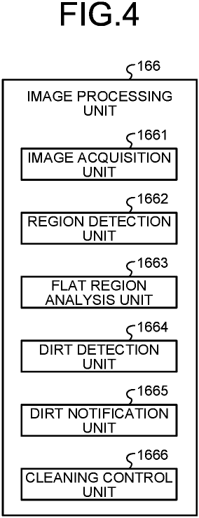

FIG. 4 is a block diagram illustrating an example of a functional configuration of the image processing unit 166 according to the first embodiment. The processor 166A of the image processing unit 166 implements various functions by reading out specific computer programs from the memory 166C, and loading the computer programs onto the RAM 166B. More specifically, the image processing unit 166 includes an image acquisition unit 1661, a region detection unit 1662, a flat region analysis unit 1663, a dirt detection unit 1664, a dirt notification unit 1665, and a cleaning control unit 1666.

The image acquisition unit 1661 acquires an image of an outside of the vehicle 1 that is captured by the in-vehicle camera 16. The image acquisition unit 1661 is an example of an acquisition unit. More specifically, the image acquisition unit 1661 acquires an image captured by the in-vehicle camera 16, from the video signal processing unit 164. For example, the image acquisition unit 1661 acquires a first captured image G1a and a second captured image G1b as images captured by the in-vehicle camera 16.

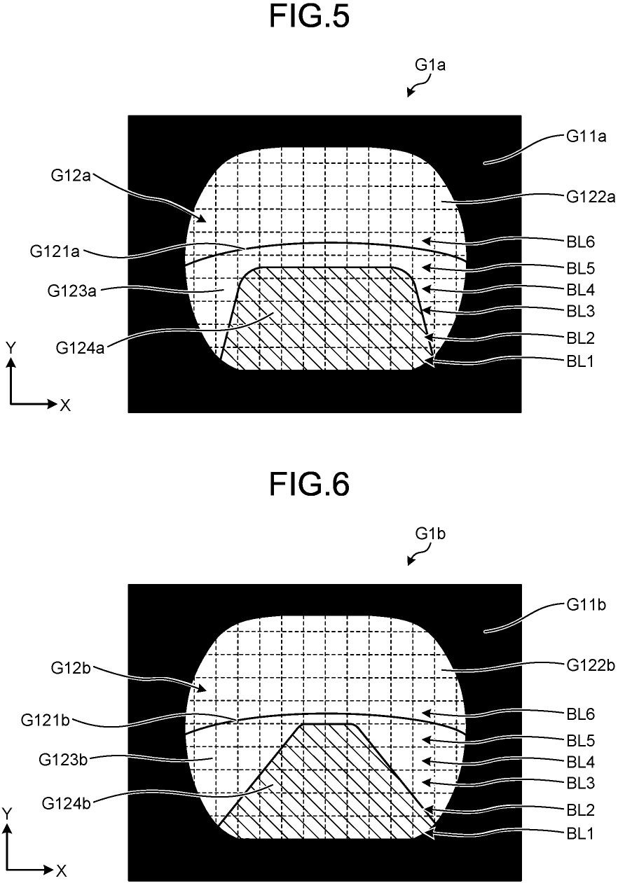

FIG. 5 is a diagram illustrating an example of the first captured image G1a. The first captured image G1a illustrated in FIG. 5 is a captured image of a rear side of the vehicle 1, and is an image captured in a state in which the sun exists slightly anteriorly to a right above position. As illustrated in FIG. 5, the first captured image G1a includes a non-image-captured region G11a and an image-captured region G12a. The non-image-captured region G11a is a detected region of the image sensor 162, but is a region in which an image of an outside of the vehicle 1 is not captured due to a casing of the in-vehicle camera 16. The image-captured region G12a illustrated in FIG. 5 is a region in which an image of an outside of the vehicle 1 is captured by light that enters via the lens 161.

The image-captured region G12a includes a horizontal line G121a, a sky region G122a, and a ground region G123a. The horizontal line G121a is a line indicating a boundary between a sky and a ground surface. The sky region G122a is a region of a sky in the first captured image G1a. The ground region G123a is a region of a ground surface in the first captured image G1a. In addition, a flat region G124a estimated to be a shadow of the vehicle 1 is formed in the ground region G123a. Because the sun exists slightly anteriorly to a position right above the vehicle 1, in the first captured image G1a illustrated in FIG. 5, the flat region G124a having an approximately-trapezoidal shape is formed. In addition, because the flat region G124a is a region estimated to be a shadow of the vehicle 1, a luminance value of the flat region G124a is lower than a first threshold. Then, the flat region G124a is a region for which a difference in luminance value among pixels is small and a variation in luminance value is small, and which has flat luminance values.

FIG. 6 is a diagram illustrating an example of the second captured image G1b. The second captured image G1b illustrated in FIG. 6 is a captured image of a rear side of the vehicle 1, and is an image captured in a state in which the sun exists in front of the vehicle 1. Similarly to the first captured image G1a illustrated in FIG. 5, the second captured image G1b includes a non-image-captured region G11b and an image-captured region G12b. In addition, the image-captured region G12b includes a horizontal line G121b, a sky region G122b, and a ground region G123b. Furthermore, in the second captured image G1b, a flat region G124b estimated to be a shadow of the vehicle 1 is formed in the ground region G123b. Because the second captured image G1b illustrated in FIG. 6 is a captured image of a rear side of the vehicle 1, and is an image captured in a state in which the sun exists in front of the vehicle 1, the flat region G124b having a shape tapered toward the horizontal line G121b from a lower portion (or a bottom portion) of the image is formed.

Note that, in a case where no discrimination between the first captured image G1a and the second captured image G1b is required, these captured images will be referred to as captured images G1. In a case where no discrimination between the horizontal line G121a of the first captured image G1a and the horizontal line G121b of the second captured image G1b is required, these horizontal lines will be referred to as horizontal lines G121. In a case where no discrimination between the sky region G122a of the first captured image G1a and the sky region G122b of the second captured image G1b is required, these sky regions will be referred to as sky regions G122. In a case where no discrimination between the ground region G123a of the first captured image G1a and the ground region G123b of the second captured image G1b is required, these ground regions will be referred to as ground regions G123. In a case where no discrimination between the flat region G124a of the first captured image G1a and the flat region G124b of the second captured image G1b is required, these flat regions will be referred to as flat regions G124.

The region detection unit 1662 detects various regions from the captured image G1 acquired by the image acquisition unit 1661. In other words, the region detection unit 1662 detects the sky region G122 and the ground region G123 from the captured image G1 acquired by the image acquisition unit 1661.

More specifically, the region detection unit 1662 detects the horizontal line G121 from the captured image G1. Then, the region detection unit 1662 detects the sky region G122 and the ground region G123 based on the horizontal line G121 included in the captured image G1 captured by the in-vehicle camera 16. The region detection unit 1662 detects a region of the captured image G1 that exists on the upper side of the horizontal line G121, as the sky region G122. In addition, the region detection unit 1662 detects a region of the captured image G1 that exists on the lower side of the horizontal line G121, as the ground region G123.

Here, the horizontal line G121 is formed at a position corresponding to an angle of the in-vehicle camera 16 with respect to a horizontal direction. For example, in a case where the in-vehicle camera 16 is oriented upward with respect to the horizontal direction, the horizontal line G121 is arranged on the lower side of the center of the captured image G1. On the other hand, in a case where the in-vehicle camera 16 is oriented downward with respect to the horizontal direction, the horizontal line G121 is arranged on the upper side of the center of the captured image G1. Accordingly, the region detection unit 1662 detects the horizontal line G121 based on an angle of the in-vehicle camera 16 with respect to the horizontal direction.

By varying an installation condition of the in-vehicle camera 16, a position of the horizontal line G121 in a captured image may be predefined. Similarly, by varying an installation condition of the in-vehicle camera 16, positions of the sky region G122 and the ground region G123 in a captured image may be predefined. In other words, the region detection unit 1662 needs not detect the horizontal line G121, the sky region G122, and the ground region G123.

The flat region analysis unit 1663 analyzes the flat region G124. Then, the flat region analysis unit 1663 determines whether or not the flat region G124 is a shadow of the vehicle 1, based on an analysis result. More specifically, the flat region analysis unit 1663 executes analysis for each of the blocks demarcated by dotted lines, which are illustrated in FIGS. 5 or 6. In other words, the flat region analysis unit 1663 determines whether or not each of the blocks in the captured image G1 corresponds to the flat region G124. The flat region analysis unit 1663 is an example of a determination unit. Then, in a case where a block corresponds to the flat region G124, the flat region analysis unit 1663 determines whether or not the block corresponds to a shadow of the vehicle 1. That is, when a row of blocks arranged in a width direction of the captured image G1 (i.e., an X-axis direction) is referred to as a block line, the flat region analysis unit 1663 determines whether a shadow of the vehicle 1 exists, while focusing attention on a change in the number of flat blocks on the block line in an up-down direction of the captured image G1 (i.e., a Y-axis direction). Here, block lines from lower portions of the images illustrated in FIGS. 5 and 6 toward the horizontal line G121 will be referred to as a first block line BL1, a second block line BL2, and block lines from a third block line BL3 to a sixth block line BL6.

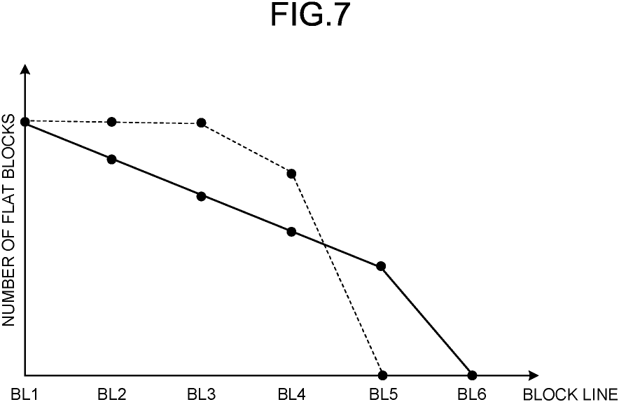

FIG. 7 is a graph illustrating an example of a shape of a shadow of the vehicle 1. A horizontal axis of the graph illustrated in FIG. 7 indicates a position of a block line. In FIG. 7, a left side of the horizontal axis corresponds to the first block line BL1, a right side of the first block line BL1 corresponds to the second block line BL2, and the position sequentially corresponds to block lines from the third block line BL3 to the sixth block line BL6. In addition, a vertical axis of the graph illustrated in FIG. 7 indicates the number of flat blocks on each block line.

A flat block is a block in which a shadow of the vehicle 1 appears. More specifically, in a case where the captured image G1 is divided into a plurality of blocks, the flat block refers to a block for which a difference in luminance value among pixels in the block is equal to or smaller than a second threshold. That is, the flat block refers to a block for which a difference between a largest luminance value and a smallest luminance value in the block is equal to or smaller than the second threshold.

In other words, two polygonal lines of the graph that are illustrated in FIG. 7 indicate shapes of shadows. In other words, the shadows indicated by the polygonal lines indicate that the number of flat blocks decreases as the block line gets closer to the horizontal line G121. In addition, a shadow indicated by a dotted line in FIG. 7 corresponds to the case illustrated in FIG. 5, and indicates that a shadow having a trapezoidal shape is formed because the sun exists slightly anterior to the position right above the vehicle 1. In addition, a shadow indicated by a solid line in FIG. 7 corresponds to the case illustrated in FIG. 6, and indicates that, because the sun exists in front of the vehicle 1, sunlight is obliquely emitted rearward from the front side of the vehicle 1, and a shadow tapered toward the horizontal line G121 from the lower portion of the image is formed. In this manner, as a block line gets closer to the horizontal line G121, the number of flat blocks on a block line right above a certain block line decreases, and the number of flat blocks on the certain block line is not increased.

Accordingly, the flat region analysis unit 1663 determines whether or not the flat region G124 is a shadow of the vehicle 1, based on whether or not the number of flat blocks on a right above block line increases as a block line gets closer to the horizontal line G121.

In addition, a shadow of the vehicle 1 is formed toward the horizontal line G121 from a position immediately below the vehicle 1. The flat region analysis unit 1663 may add, to a condition of determination as to whether or not the flat region G124 is a shadow of the vehicle 1, whether or not the flat region G124 is formed toward the horizontal line G121 from a lower portion of the captured image G1. Furthermore, a shadow of the vehicle 1 is formed on the ground surface. Accordingly, the flat region analysis unit 1663 may add, to a condition of determination as to whether or not the flat region G124 is a shadow of the vehicle 1, whether or not the flat region G124 is formed on the ground region G123 of the captured image G1.

The dirt detection unit 1664 detects dirt adhering to the in-vehicle camera 16, based on the captured image G1 captured by the in-vehicle camera 16.

Here, in a case where dirt such as mud adheres to the lens 161 of the in-vehicle camera 16, the image sensor 162 becomes unable to receive visible light, due to high-density dirt adhering to the lens 161. Thus, a luminance value of an image corresponding to a portion to which dirt adheres becomes low. In other words, an image corresponding to a portion to which dirt adheres becomes a region for which a difference in luminance value among pixels is small and which has flat luminance values. Accordingly, the dirt detection unit 1664 determines whether or not dirt adheres, based on a ratio of a region for which a difference in luminance value among pixels included in the captured image G1 is small and which has flat luminance values.

In a case where a given condition is satisfied in the captured image G1 captured by the in-vehicle camera 16, the dirt notification unit 1665 notifies that dirt adheres to the lens 161 of the in-vehicle camera 16. The dirt notification unit 1665 is an example of a notification unit. In other words, in a case where it is determined by the dirt detection unit 1664 that dirt adheres to the lens 161 of the in-vehicle camera 16, the dirt notification unit 1665 notifies that dirt adheres to the lens 161 of the in-vehicle camera 16. In addition, the given condition is a case where a ratio of a region, for which a difference in luminance value among pixels in the image is small and which has flat luminance values, is equal to or larger than a threshold.

For example, the dirt notification unit 1665 notifies that dirt adheres to the lens 161 of the in-vehicle camera 16, by displaying the notification on the display device 120 or the like. Note that a notification method is not limited to the display device 120, and the dirt notification unit 1665 may make a notification by voice, may make a notification by causing a light emitting diode (LED) or the like to light up, or may make a notification by another method.

Even in a case where a ratio of a region, for which a difference in luminance value among pixels is small and which has flat luminance values in the captured image G1, is equal to or larger than a threshold, dirt does not adhere to the lens 161 of the in-vehicle camera 16 in some cases. In such cases, the dirt notification unit 1665 does not notify that dirt adheres to the lens 161 of the in-vehicle camera 16.

In a case where the flat region G124 being a region, for which a difference in luminance value among pixels included in the captured image G1 is small and which has flat luminance values, gets narrower in a width direction as getting farther from the vehicle 1 in the captured image G1, the dirt notification unit 1665 does not notify that dirt adheres to the lens 161 of the in-vehicle camera 16. In other words, in a case where the flat region G124 has a shape of a shadow of the vehicle 1, the dirt notification unit 1665 does not notify that dirt adheres to the lens 161 of the in-vehicle camera 16.

In a case where the number of flat blocks in the flat region G124 in the horizontal direction of the captured image G1 determined by the flat region analysis unit 1663 is not increased as the distance from the vehicle 1 increases in the captured image G1, the dirt notification unit 1665 does not notify that dirt adheres to the lens 161 of the in-vehicle camera 16. In other words, in a case where the number of flat blocks in the flat region G124 indicates a shape of a shadow of the vehicle 1, the dirt notification unit 1665 does not notify that dirt adheres to the lens 161 of the in-vehicle camera 16.

In a case where the flat region G124 included in the captured image G1 is formed toward the horizontal line G121 from the lower portion of the captured image G1, the dirt notification unit 1665 does not notify that dirt adheres to the lens 161 of the in-vehicle camera 16. In other words, in a case where the flat region G124 satisfies a condition of being formed toward the horizontal line G121 from the lower portion of the captured image G1, which is one of conditions for consisting with a shadow of the vehicle 1, the dirt notification unit 1665 does not notify that dirt adheres to the lens 161 of the in-vehicle camera 16.

In a case where the flat region G124 included in the captured image G1 is formed in a region of a ground surface of the captured image G1, the dirt notification unit 1665 does not notify that dirt adheres to the lens 161 of the in-vehicle camera 16. In other words, in a case where the flat region G124 satisfies a condition of being formed in a region of a ground surface of the captured image G1, which is one of conditions for consisting with a shadow of the vehicle 1, the dirt notification unit 1665 does not notify that dirt adheres to the lens 161 of the in-vehicle camera 16.

The cleaning control unit 1666 controls the cleaning unit 163 to clean the lens 161 of the in-vehicle camera 16. For example, in a case where it is detected by the dirt detection unit 1664 that dirt adheres, the dirt notification unit 1665 displays, on the display device 120, a notification indicating that dirt adheres to the lens 161. A manipulator such as an operator accordingly inputs an operation of causing the cleaning unit 163 to execute cleaning, using the operation button 141 or a touch panel included in the display device 120. Then, in a case where the cleaning control unit 1666 receives the operation of causing the cleaning unit 163 to execute cleaning, the cleaning control unit 1666 causes the cleaning unit 163 to clean the lens 161.

Next, a flow of shadow determination processing to be executed by the image processing unit 166 will be described.

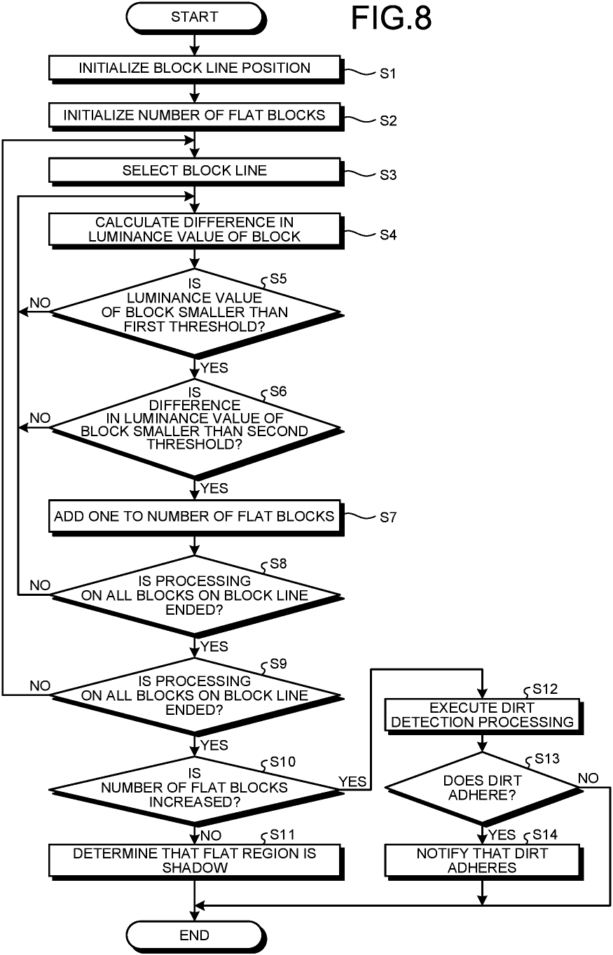

FIG. 8 is a flowchart illustrating an example of shadow determination processing to be executed by the image processing unit 166 according to the first embodiment.

The flat region analysis unit 1663 initializes a variable indicating a position of a processing target block line (Step S1). The flat region analysis unit 1663 initializes a variable indicating the number of flat blocks (Step S2).

The flat region analysis unit 1663 selects a processing target block line (Step S3). That is, the flat region analysis unit 1663 designates one indicating a block line positioned in a lower portion of the ground region G123 that is to be processed first, as a variable indicating a position of a processing target block line.

The flat region analysis unit 1663 calculates a difference in luminance value of a processing target block on a processing target block line (Step S4). That is, the flat region analysis unit 1663 subtracts a smallest luminance value from a largest luminance value in the processing target block.

The flat region analysis unit 1663 determines whether or not a luminance value of the processing target block is smaller than a first threshold (Step S5). In other words, when determining whether or not the processing target block is a shadow, the flat region analysis unit 1663 determines whether or not the processing target block is a candidate of a shadow. Here, the luminance value may be an average value in the block, may be a largest value in the block, may be a smallest value in the block, or may be another value in the block.

In a case where the luminance value is equal to or larger than the first threshold (Step S5; No), the flat region analysis unit 1663 shifts the processing to Step S4, and executes processing on another block on the block line.

In a case where the luminance value is smaller than the first threshold (Step S5; Yes), the flat region analysis unit 1663 determines whether or not a value obtained by subtracting the smallest luminance value from the largest luminance value in the processing target block is smaller than a second threshold (Step S6). In other words, the flat region analysis unit 1663 determines whether or not the processing target block is a flat block.

In a case where a value obtained by subtracting the smallest luminance value from the largest luminance value is equal to or larger than the second threshold (Step S6; No), the flat region analysis unit 1663 shifts the processing to Step S4, and executes processing on another block on the block line.

In a case where a value obtained by subtracting the smallest luminance value from the largest luminance value is smaller than the second threshold (Step S6; Yes), the flat region analysis unit 1663 adds one to the number of flat blocks on the block line (Step S7).

The flat region analysis unit 1663 determines whether or not processing on all blocks on the block line is ended (Step S8). In a case where processing on all blocks is not ended (Step S8; No), the flat region analysis unit 1663 shifts the processing to Step S4, and executes processing on another block on the block line.

In a case where processing on all blocks on the block line is ended (Step S8; Yes), the flat region analysis unit 1663 determines whether or not processing on all block lines is ended (Step S9). In a case where processing on all block lines is not ended (Step S9; No), the flat region analysis unit 1663 shifts the processing to Step S3, and executes processing on another block line.

In a case where processing on all block lines is ended (Step S9; Yes), the flat region analysis unit 1663 determines whether or not the number of flat blocks is increased in a case where a block line from which the number of flat blocks is acquired is sequentially changed upward (Step S10). In other words, the flat region analysis unit 1663 determines whether or not the number of flat blocks on a certain block line is equal to or smaller than or is increased from the number of flat blocks on a block line positioned right above the block line.

In a case where the number of flat blocks on a block line existing at an upper position is not increased as illustrated in FIG. 7 (Step S10; No), the flat region analysis unit 1663 determines that the flat region G124 is a shadow (Step S11). In addition, the dirt notification unit 1665 determines not to make a notification.

In a case where the number of flat blocks is not illustrated in FIG. 7 (i.e., is increased) (Step S10; Yes), the dirt detection unit 1664 executes, as an example of dirt detection processing, for example, dirt detection processing of detecting dirt adhering to the lens 161 of the in-vehicle camera 16, based on a ratio of a region for which luminance values are flat in an image (Step S12).

Note that the dirt detection processing of the dirt detection unit 1664 is not limited to this. Dirt may be detected utilizing a principle in which appearance of dirt in an image does not change during the movement of the vehicle 1 although a background changes. In other words, by acquiring a histogram for a small region in an image, and detecting that there is no temporal change in the histogram, it may be determined whether or not dirt adheres to the lens 161.

The dirt detection unit 1664 determines whether or not a detection result of the dirt detection processing indicates that dirt adheres (Step S13).

In a case where the detection result indicates that dirt adheres (Step S13; Yes), dirt notification unit 1665 notifies that dirt adheres to the lens 161 of the in-vehicle camera 16 (Step S14).

In a case where the detection result indicates that no dirt adheres (Step S13; No), the image processing unit 166 ends the shadow determination processing.

As described above, the image processing unit 166 according to the first embodiment acquires the captured image G1 of the outside of the vehicle 1 that is captured by the in-vehicle camera 16. In addition, in a case where a ratio of a region, for which a difference in luminance value among pixels is small and which has flat luminance values in the captured image G1, is equal to or larger than a threshold, the image processing unit 166 notifies that dirt adheres to the lens 161 of the in-vehicle camera 16. Nevertheless, in a case where the flat region G124 gets narrower in a width direction as getting farther from the vehicle 1 in the captured image G1, the image processing unit 166 does not notify that dirt adheres to the lens 161 of the in-vehicle camera 16.

In other words, even if a ratio of a region, for which a difference in luminance value among pixels is small and which has flat luminance values, is equal to or larger than a threshold, in a case where a shape of the flat region G124 indicates a shape of a shadow of the vehicle 1, the image processing unit 166 determines that no dirt adheres to the lens 161, and does not make a dirt adherence notification. The image processing unit 166 can accordingly prevent false detection of a state in which dirt adheres to the lens 161 of the in-vehicle camera 16.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image monitoring device comprising:
a memory; and
one or more hardware processors coupled to the memory and configured to function as:
an acquisition unit configured to acquire an image of an outside of a vehicle that is captured by an imaging unit; and
a notification unit configured to, in a case where a given condition is satisfied in the image, notify that dirt adheres to a lens of the imaging unit, wherein,
in a case where a flat region being a region, for which a difference in luminance value among pixels included in the image is small and which has flat luminance values, gets narrower in a width direction of the region as getting farther from the vehicle in the image, the notification unit does not notify that the dirt adheres to the lens of the imaging unit.

2. The image monitoring device according to claim 1, wherein the given condition is a case where a ratio of the region, for which the difference in luminance value among the pixels in the image is small and which has flat luminance values, is equal to or larger than a threshold.

3. The image monitoring device according to claim 1, wherein the one or more hardware processors are configured to further function as:
a determination unit configured to determine whether or not each of a plurality of blocks in the image is the flat region, wherein
in a case where a number of blocks in the flat region in a horizontal direction of the image determined by the determination unit is not increased as a distance from the vehicle increases in the image, the notification unit does not notify that the dirt adheres to the lens of the imaging unit.

4. The image monitoring device according to claim 1, wherein, in a case where the flat region included in the image is formed toward a horizontal line from a lower portion of the image, the notification unit does not notify that the dirt adheres to the lens of the imaging unit.

5. The image monitoring device according to claim 1,
wherein, in a case where the flat region included in the image is formed in a region of a ground surface of the image, the notification unit does not notify that the dirt adheres to the lens of the imaging unit.
